(19) United States
(12) Patent Application Publication
(10) Pub. No.: US 2003/0023486 A1
(43) Pub. Date: Jan. 30, 2003

(54) Systems and methods for automatically generating advertising registration marks

(76) Inventor: Jerry Pavelka, Chicago, IL (US)

Correspondence Address: Robert J. Depke, MAYER, BROWN & PLATT, P.O. Box 2828, Chicago, IL, 60690-2828, US

(21) Appl. No.: 09/917,134

(22) Filed: Jul. 27, 2001

(51) Int. Cl. G06F 17/60

(52) U.S. Cl. 705/14

(57) ABSTRACT

A software program or module accepts a variety of user designations for such things as, for example, the width and height of various advertising registration marks including one or more of the following: trim marks, bleed marks, live marks, and gutter marks. The software program or module interacts with or is embodied within an overall program for manipulation and generation of advertising image information. The computer program automatically places the designated advertising registration marks within the image file of advertisements to be published. Additionally, systems and methods are provided for scaling advertising layout image information along with corresponding advertising registration marks in order to match the requirements for various sizes of advertising copy.

### BACKGROUND OF THE INVENTION

1. Field of the Invention

The present invention is generally directed to the field of advertising image generation systems. More specifically, the present invention is directed to systems and methods for automatically generating various registration marks for use in the generation of print advertisements. Additionally, the systems and methods of the present invention, in an alternate preferred exemplary embodiment, provide the ability to scale advertising layouts in order to satisfy the requirements for various sizes of advertising copy. Yet another aspect of the present invention is that data concerning specified values for various registration marks required by particular publishers may be automatically updated electronically in order to ensure that the most up-to-date information is utilized.

2. Description of the Related Art

In the preparation of conventional print advertisements, in order to ensure that publishers print the appropriate advertising copy without inadvertently clipping some of the desired artwork, it is a well accepted and long-standing practice to include a variety of advertising layout registration marks along with the advertising copy transmitted to the printer or publisher. For example, these registration marks include such things as trim marks, bleed marks, live marks, center marks and gutter marks. These various registration marks have a very special meaning in the advertising industry and are used to ensure that an advertisement is printed as desired.

Trim marks are advertising registration marks which determine where the advertising layout is to be physically cut by a blade. Bleed marks provide a safety zone that extends out beyond the trim area. This safety zone provides a cushion should the blade miss the trim mark when cutting the layout. These marks are utilized in order to ensure that there is no white paper if the blade inadvertently misses the trim mark location. Live marks define the area inside the trim mark which ensures that essential information such as type, logo and the like is not lost during the trimming process. Gutter marks or gutter width provides a safety zone on the left and right hand side of the center of an advertising spread that is to be located between or across two pages.

These various advertising registration marks are well-recognized in the field and may be currently generated with a variety of computer programs that are used to generate advertising image information. For example, these programs include Adobe Illustrator, Adobe Indesign and QuarkXPress. Those skilled in the art will recognize that other computer programs for generating image information may be utilized as well for generating advertising registration mark image information. These conventional programs are used to generate a digital representation of an advertising layout. In using these programs, conventional techniques for generating the various advertising registration marks require that the user manually locate or place the lines on the advertising layout. This requires that a user first select a page size for the layout. The registration marks are then made with reference to the page size. A user is required to identify a reference point and then physically maneuver a cursor to each of the desired locations for each of the registration marks. This is a very time-consuming process even when utilizing programs which are designed for the generation of advertising image information. There currently is no automated system or technique for generating the various advertising registration marks and placing them within a file containing digital image information.

Use of the conventional image generating programs requires a very time-consuming and tedious process in order to ensure the appropriate placement of the various advertising registration marks. It is critical that dimensions and scale be maintained during this process in order for the artwork to be printed as desired. Currently manual measurement and placement of the marks in each of the image generating programs is performed. Those skilled in the art are well aware that this is a difficult and time-consuming process. In conventional systems, this is typically performed by identifying a reference location within a display of advertising image information. The various registration marks are then generated to scale with reference to the reference location which may be either the center or corner of the image information. Each individual line defining the registration information must be manually placed in the systems.

In light of the foregoing, there remains a need in the advertising field for systems and methods that may be used to automatically generate various advertising registration marks within a file containing image information. Additionally, there remains a need in the advertising field for systems and methods that may be utilized to quickly and easily enter various advertising registration marks in a file containing image information.

Yet another shortcoming of conventional advertising layout generation systems is that they currently do not provide users with the ability to scale an advertising layout file to fit various sizes of advertising copy. For example, if an advertising layout is created for an 8 ½ by 11 space, along with the desired advertising registration marks, the entire layout must be re-created in order to fit another size such as, for example, a 4 by 5 space. Accordingly, when utilizing conventional systems a user must repeat the time-consuming process of manually laying out each of the various advertising registration marks for the new size advertisement. There are currently no systems available which provide users with the ability to scale an entire advertising layout along with its corresponding registration marks to fit within a different size advertising space.

Yet another shortcoming of existing systems is that there is currently no ability to automatically update information concerning the required dimensions of various registration marks as specified by various publishers. Currently, individuals are required to manually lookup this information before creating an advertising layout. Accordingly, there remains a need for systems and methods which may be utilized to automatically provide this information to a person who is creating an advertising layout.

Accordingly, it is one object and advantage of the present invention to provide systems and methods for automatically generating various advertising registration marks in a file containing image information. It another object and advantage of the present invention to provide systems and methods for generating various advertising registration marks which are compatible with existing software packages. It is another object and advantage of the present invention to provide systems and methods for automatically scaling various registration marks in an advertising layout. It is yet another object an advantage of the present invention to provide systems and methods for automatically scaling advertising layouts along with their registration marks to fit different sizes of advertising spaces. Yet another alternate object and advantage of the present invention is to provide systems and methods which may be utilized for automatically providing specified values for registration marks in advertising layouts required by various publishers. Other objects and advantages of the present invention will be apparent in light of the following Summary and Detailed Description of the Presently Preferred Embodiments.

### SUMMARY OF THE INVENTION

The present invention is generally directed to a variety of systems and methods for automatically generating various advertising registration marks to be used in an advertising layout. In accordance with a preferred exemplary embodiment of the present invention, a software program or module can be used to interface with a variety of existing conventional image generation programs including Adobe Illustrator, Adobe Indesign and QuarkXPress. The software program or module may be used to automatically generate a variety of desired advertising registration marks and incorporate them into image information generated and displayed through these various programs.

The software program or module accepts a variety of user designations for such things as, for example, the width and height of various advertising registration marks including one or more of the following: trim marks, bleed marks, live marks, and gutter marks. Additionally, the preferred embodiment of the computer program or module includes user designated inputs for such things as stroke width which is the line width for the various advertising registration marks being created and displayed by the program module. In the preferred exemplary embodiment of the present invention, a user may also selectively enter the scale factor. The scale factor allows the user to set a size ratio. The default setting is preferably set to a one-to-one correspondence. The feature allows a user to build an advertising layout and scale size but still show the dimensions at full-size.

In accordance with an exemplary embodiment of the present invention, a user is able to easily enter the desired dimensions for the various advertising registration marks. The software program in the preferred exemplary embodiment provides the user with the ability to generate each of the following advertising registration marks: trim marks, bleed marks, live marks, and gutter marks. Those skilled in the art will recognize that it is not necessary for the program to include the ability to generate each and every one of the referenced registration marks. Furthermore, it is contemplated that the systems and methods of the present invention may be utilized to make other types of registration marks as well.

The software program or module of the preferred exemplary embodiment interacts with the image generation programs to automatically insert the various desired registration marks within the image file. This is accomplished based on information regarding the size and scale of the underlying artwork. Based on this information and the user specified dimensions for the selected advertising registration marks, the system calculates the appropriate placement of the marks within the existing image information. The image is also modified in one embodiment to include these modifications. In accordance with a preferred exemplary embodiment of the present invention, each of the various registration marks generated in accordance with the systems and methods of the present invention are located with respect to a selected reference location in the image information. This reference location may be set by default to be the center of the image information. In such an embodiment, the bleed registration marks are located preferably at the image boundaries based on the dimensions of the available image information and the distances from the reference point such as, for example, the center of the image information file. Those skilled in the art will appreciate that it is not necessary to locate the bleed marks precisely at the boundaries of the image information. In an alternate preferred exemplary embodiment, a user is able to specify a particular reference point from which each of the registration marks will be subsequently generated. For example, a user may prefer that a particular portion of the image information may be utilized and another portion discarded. In such a situation, the user places the reference location in the corner of the image information nearest the desired portion of the image. Thereafter, based on scale factors for the specified dimensions of the various registration marks, the registration marks are generated for placement within the image data.

This provides a simple and easily mechanism for a user to generate any desired advertising registration marks. Those skilled in the art will appreciate that the software program or module may be incorporated into an overall program for generating and/or modifying image information. Specifically, an image manipulation program such as, for example, Adobe Illustrator, Adobe InDesign and QuarkXPress may be modified to include the program module within the overall program in order to accomplish similar results. In the preferred exemplary embodiment, the software program or module is a plug-in module which interacts with any one of the selected image generation programs.

In accordance with another exemplary embodiment of the present invention, the software program or module interacts with a database containing the requisite advertising registration layout dimensions for a particular publication. Specifically, for example, certain publications dictate that digital information comprising an advertising layout be in a specified format which includes the various registration marks in a certain size or dimension. As a result, in order to further facilitate the ease-of-use and simplification of the advertising registration marks insertion into an image file, this exemplary embodiment of the present invention includes a database which correlates a publication with its registration mark requirements or sizes.

In such embodiment, if a person is preparing an advertisement for publication in a certain magazine, the user simply selects a pulldown menu that identifies the appropriate dimensions for the various advertising registration marks. If the user wishes to select these default settings, the system automatically populates the selections into the appropriate fields so that the data may be utilized by the system.

For example, the database may contain the correlation between magazines such as, Time magazine, Newsweek, Reader's Digest etc. and each of their respective layout requirements for the various registration marks to the extent that they exist. In this embodiment of the invention, a user simply designates a magazine name along with the size of the ad layout and the program will pre-populate each of the various designated fields for specification of the dimensions for the various advertising registration marks. The user can then readily accept or reject the pre-populated designations by manually modifying the designations. This further facilitates and simplifies the overall process of entering the various advertising registration marks.

In yet a further alternate exemplary embodiment of the present invention, the database containing information on the various specified values for the advertising layout registration marks is periodically updated. This may be accomplished via electronic mail or manually inputting data regarding the change values. In yet a further alternate embodiment, the database containing information concerning various advertising registration mark requirements does not directly contain information on the values. Rather, the database contains links to the information. These links may be to one or more web sites that may be utilized to provide the information. For example, each of several publishers may maintain their own respective databases containing information on each of their respective requirements for specified values of various advertising layout registration marks. A user is able to readily acquire the appropriate registration mark data simply by clicking on the appropriate link and thereby transferring the most recent information concerning these requirements. As a result, the computer program is able to readily acquire this data for insertion of the appropriate registration marks.

In yet another alternate exemplary embodiment of the present invention, a refined version of the system provides independent scalability between underlying image information and the various registration marks. For example, a user may have a file that contains image information as well as various advertising registration marks. If the user prefers to adjust the image information such that a different portion of the image is contained within the registration marks a user may selectively scale the image information with respect to the registration marks. This feature advantageously allows users to easily alter or adjust the specific location of certain of the registration marks with respect to the underlying image information.

In this preferred exemplary embodiment, the user may adjust the scale of the underlying image information so that it grows or shrinks within a template of specified registration marks. The display shows relative location of marks in the underlying image data. Alternatively, the user may select to independently scale the registration marks with respect to the image information. This is accomplished simply by clicking on one of the registration marks and dragging it either towards or away from the center of the image information.

In yet another alternate preferred exemplary embodiment of the present invention, once an advertising layout along with its corresponding advertising registration marks has been created, the system provides the user with the ability to selectively scale this image information to match another size for an advertising layout. Specifically, in this exemplary embodiment, the various layers of image information may be appropriately scaled in order to match another size for the layout. For example, if an advertising layout has been generated for an 8½ by 11 space, along with the appropriate registration marks, the system provides a user with the ability to scale this information in order to fit the ad to another size advertising space.

In order to accomplish this task, the system utilizes the size information for the existing advertising copy and then selectively scales each of the various layers of image information in order to provide the newly sized advertising layout. Those skilled in the art will appreciate that advertising layouts are typically comprised of three or four or possibly more different layers of image information. One layer typically contains the advertisement type and/or logo. Another layer contains any picture information which may accompany the advertisement. Yet another layer contains advertising registration mark information.

The system independently scales each of the various layers in order to provide a modified composite image of the advertising layout for another scaled size. As in the embodiments described above, placement of the registration marks subsequent to scaling of the image data is accomplished by locating the registration marks with respect to a center of the image information or other reference point such as, for example, a selected corner of the image information. As noted above, this corner may be selected in order to maintain a desired portion of the image within the live area of the image file.

In yet another preferred exemplary embodiment of the invention, the system utilizes a combination of the overall advertising layout scalability feature in conjunction with a database of registration mark information for various publications in order to ensure that the newly scaled registration marks for the corresponding underlying scaled image information is appropriate for the particular publication in which the scaled advertisement will be placed. For example, in the preferred exemplary embodiment, once both the image and the registration marks have been scaled to match the newly designated advertising copy size, the user is presented with the option of automatically adjusting the registration marks to match the requirements for a particular publication. Accordingly, a user is able to scale advertising layouts in order to match various size requirements while also ensuring that the registration marks accompanying the scaled advertising copy are appropriate for a given publication.

### BRIEF DESCRIPTION OF THE DRAWINGS

FIG. 1 illustrates a block flow diagram of an exemplary embodiment of the present invention;

FIG. 2 illustrates a display for entry of user defined information in an exemplary embodiment of the present invention;

FIG. 3 illustrates a block flow diagram of an exemplary embodiment of the present invention;

FIG. 4 illustrates a block diagram of an alternate exemplary embodiment of the present invention;

FIG. 5 illustrates a block diagram of an alternate exemplary embodiment of the present invention;

### DETAILED DESCRIPTION OF THE PRESENTLY PREFERRED EMBODIMENTS

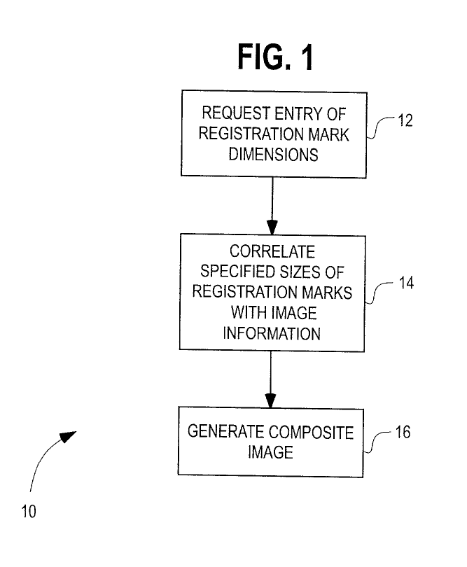

FIG. 1 illustrates a first exemplary of the present invention which is shown generally at 10. In accordance with the first exemplary embodiment, in a first step 12 the computer program or module requests entry of user specified values for a number of different advertising registration marks. These registration marks include such things as, for example, trim marks, bleed marks, live marks, and gutter marks. Those skilled in the art will recognize that it is not necessary for the program to include the ability to generate each and every one of the referenced registration marks. However, it is preferred that the program be capable of generating all of referenced marks.

In a second step 14, the system correlates the specified advertising registration marks with image information of the corresponding program. As noted above, in the preferred exemplary embodiment, the computer software is embodied as a plug-in module for an image generating program. Size and scale information for the underlying image data is acquired so that the registration marks may be properly aligned with the image data. During the alignment process, the locations for the various registration marks to be inserted in the image information are determined with respect to a reference point. For example, as noted above, the reference location may be selected to be the center of the image datafile. Alternatively, a user may be allowed to point and click on a particular location within the image data for the purpose of identifying a reference point. Specifically, for example, the user may be allowed to select a corner of the image data as the reference point. Once a reference point is selected, the locations for the various registration marks are calculated with respect to the reference information. This is accomplished based on information concerning the underlying image size.

Once these calculations have been made, the program module inserts the image data corresponding to the advertising registration marks into the underlying image data that a composite image may be provided with the registration marks include therein. This occurs in step 16.

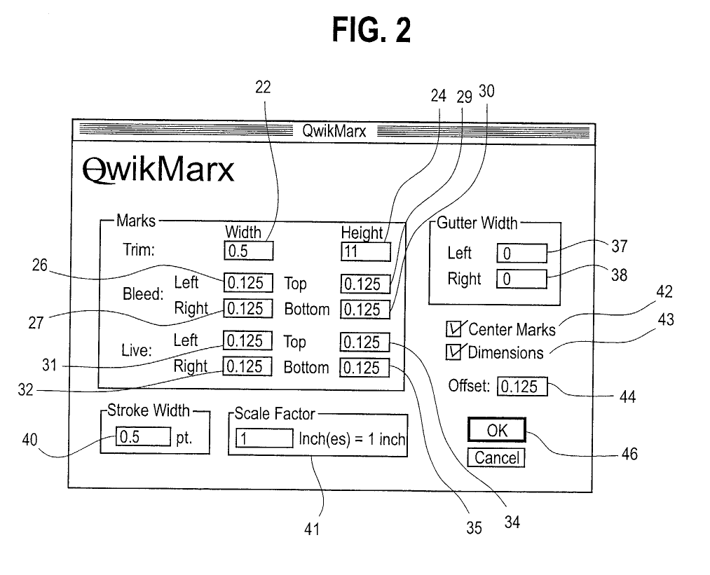

FIG. 2 is an illustration which details the various data entry fields presented to a user for entry of the desired advertising registration marks. The software program or module accepts a variety of user designations for such things as, for example, the width and height of various advertising registration marks including one or more of the following: trim marks, bleed marks, live marks, and gutter marks. As shown in FIG. 2, in data entry field 22 a user enters the width of the desired trim marks. In data entry field 24 the user enters the height of the desired trim marks. Data entry fields 26, 27 allow users to enter the left and right dimensions for bleed marks. Data entry fields 29, 30 allow users to enter top and bottom dimensions for bleed marks. The dimensions for the left and right live marks are entered in data entry fields 31, 32. The top and bottom live registration mark dimensions are entered in data entry fields 34, 35. Users may selectively enter dimensions for left and right gutter marks in data entry fields 37, 38.

The stroke width or width of the various registration marks entered by a user is defined in data entry field 40. Data entry field 41 allows a user to selectively enter the scale factor. A user may also select to have the marks centered by selecting option 42. The dimensions may be selected in option 43. A user may also selectively enter an offset value in data entry field 44. When a user is satisfied with the various specified values, clicking the box 46 initiates operation of the program which actually enters the various registration marks.

Specifically, the computer program analyzes the various specified dimensions input by a user as well as the size and scale information of the underlying image data. The program then calculates the appropriate location for placement of the various registration marks and inserts them into the image information. As noted above, these calculations are typically made with respect to a reference point. The reference point is typically the center of the image information file or, as noted, may alternatively be a user selected or designated area such as a corner of the image file.

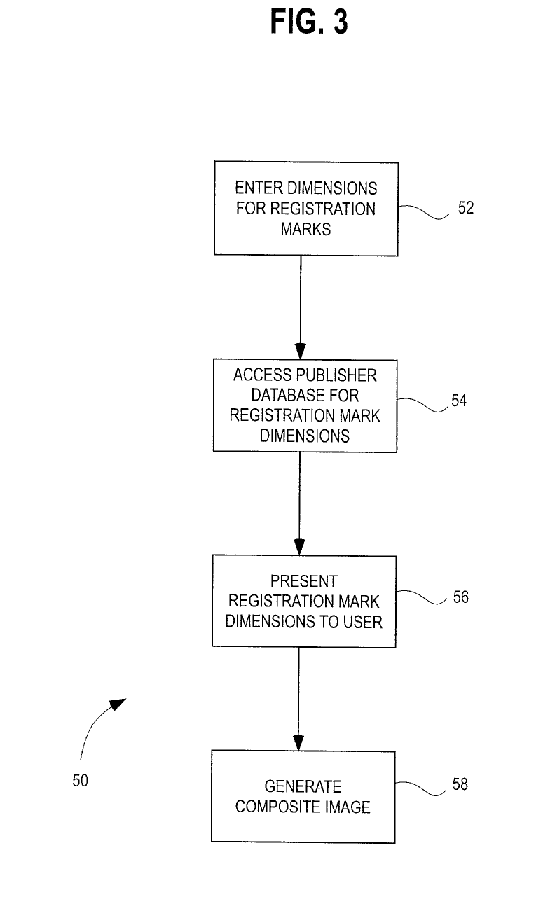

FIG. 3 illustrates an alternate exemplary of the present invention that is shown generally at 50. In accordance with this exemplary embodiment, in a first step 52 the computer program or module requests entry of user specified values for a number of different advertising registration marks or alternatively, the user may selectively enter identification of the specific publisher or other designation which may be used to pre-populate the various data entry fields for defining dimensions of the various advertising registration marks. These registration marks include such things as, for example, trim marks, bleed marks, live marks, and gutter marks.

In a second step 54, the system accesses information contained in a database or other memory which correlates the specified publisher or other designation with the pre-defined stored dimensions for the various advertising registration marks. The information is then presented to the user by pre-populating the various data entry fields with the stored dimensions for the various registration marks. This occurs in step 56. The user may then select to accept or reject the predefined dimensions. Upon acceptance, the system automatically generates image information with the various registration marks properly placed. This occurs in step 58.

The database containing information on the various specified values for the advertising layout registration marks is periodically updated. This may be accomplished via electronic mail or manually inputting data regarding the change values. Specifically, for example, the system is configured to automatically process electronic mail data transfers from publishers or other entities. In such an embodiment the electronic mail data transfers are utilized in order to update the databases containing specified values for the registration mark data. Those skilled in the art will appreciate that this data may be transferred in other manners as well. In yet a further alternate embodiment, the database containing information concerning various advertising registration mark requirements does not directly contain information on the values. Rather, the database contains links to the information. These links may be to one or more web sites that may be utilized to provide the information. For example, each of several publishers may maintain their own respective databases containing information on each of their respective requirements for specified values of various advertising layout registration marks. A user is able to readily acquire the appropriate registration mark data simply by clicking on the appropriate link and thereby transferring the most recent information concerning these requirements. This data may then be utilized by the registration mark generation program. As a result, the computer program is able to readily acquire this data for insertion of the appropriate registration marks.

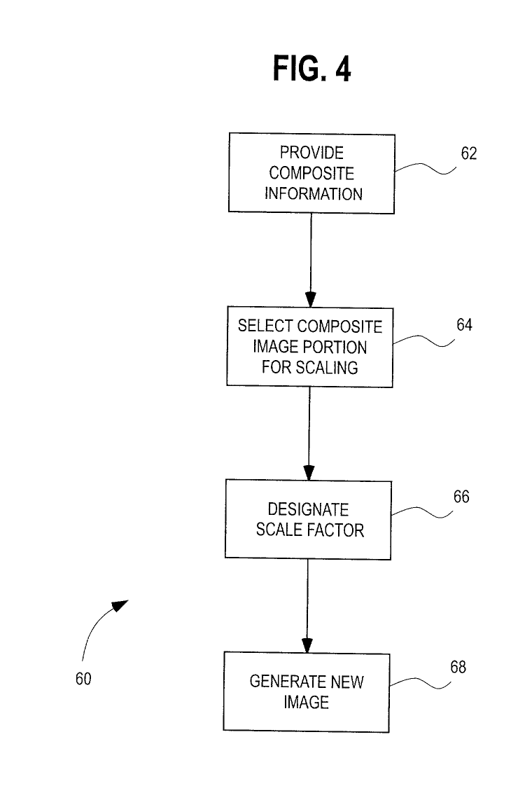

FIG. 4 illustrates yet another alternate exemplary embodiment of the present invention which is shown generally at 60. This alternate exemplary embodiment of the system provides independent scalability between underlying image information and the various registration marks. For example, a user may have a file that contains image information as well as various advertising registration marks. If the user prefers to adjust the image information such that a different portion of the image is contained within the registration marks a user may selectively scale the image information with respect to the registration marks. This feature advantageously allows users to easily alter or adjust the specific location of certain of the registration marks with respect to specific portions of the underlying image information.

In this preferred exemplary embodiment, the user may adjust the scale of the underlying image information so that it grows or shrinks within a template of specified registration marks. The display shows relative location of marks in the underlying image data. Alternatively, the user may select to scale the registration marks with respect to the image information. This is accomplished simply by clicking on one of the registration marks and dragging it either towards or away from the center of the image information.

As shown in FIG. 4, in a first step 62 composite image information is provided to the system which includes both underlying image information as well as one or more of the various advertising registration marks. In step 64 a user is presented with an option of selecting a portion of the composite image for scaling. Specifically, in this step the user selects either the registration marks or the underlying image information for scaling. Those skilled in the art will recognize that an advertising layout composite image is generally comprised of multiple layers which typically include a layer for the registration marks and one or more layers of underlying image information including both text and logo data as well as any associated picture information. In this step a user is presented with the option of selecting one or more of these layers for independent scaling thereby allowing flexibility in the relative placement of the various registration marks with respect to the underlying image information. In step 66 the user designates a scale factor. This may be accomplished by entering of numeric size multiplication information and/or by clicking and dragging either towards or away from a center of the image data. When the scale factor has been designated in step 66, the system then generates a new composite image in step 68. Those skilled in the art will appreciate that this step may be a dynamic step in that the new image information may be continuously generated based on dragging of a portion of the image as noted above.

In yet another alternate preferred exemplary embodiment of the present invention, once an advertising layout along with its corresponding advertising registration marks has been created, the system provides the user with the ability to selectively scale this image information to match another size for an advertising layout. Those skilled in the art will appreciate that advertising layouts are typically generated in a variety of different sizes. Typical sizes include 8½ by 11 inches and four inches by five inches, for example.

In this exemplary embodiment, the various layers of image information may be appropriately scaled in order to match another size for the overall layout. For example, if an advertising layout has been generated for an 8 ½ by 11 space, along with the appropriate registration marks, the system provides a user with the ability to scale this information in order to fit the ad to another size advertising space. In order to accomplish this task, the system utilizes the size information for the existing advertising copy and then selectively scales each of the various layers of image information in order to provide the newly sized advertising layout. Those skilled in the art will appreciate that advertising layouts are typically comprised of three or four or possibly more different layers of image information. One layer typically contains the advertisement type and/or logo. Another layer contains any picture information which may accompany the advertisement. Yet another layer contains advertising registration mark information.

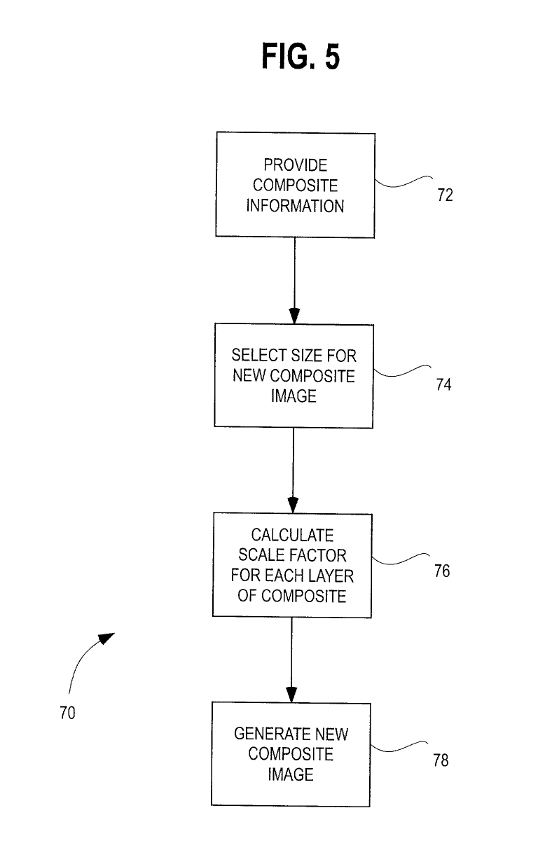

The system independently scales each of the various layers in order to provide a modified composite image of the advertising layout for another scaled size. The steps for accomplishing advertising layout scaling are illustrated in FIG. 5 wherein the overall process is shown generally at 70. In a first step 72, the system is provided with composite image information including underlying image data which may be comprised of logo and type information as well as picture data along with any desired registration marks. In step 74, the user selects a size for the new composite image. This may be accomplished by user entry into data fields and/or selecting pre-designated sizes from drop-down menus, for example. It should be recognized that virtually any type of data entry may be utilized in order to identify the new image size. In step 76, the system calculates a scale factor for each layer of the composite image information. Thereafter in step 78, the system generates a new composite image based on the underlying image data for each layer and the scale factor. Those skilled in the art will recognize that some of the required dimensions for various registration marks designated by various publications will not be directly scalable from one ad size to another. Accordingly, in a preferred exemplary embodiment of the system, prior to generation of the new composite image the user is presented with an option of either designating a publication for which the new ad size will be generated and/or simply entering each of the new dimensions for the registration marks which are to accompany the new advertising layout size. The registration marks are then added to the composite image as described above. It should be recognized that the composite image information without the registration marks may be initially generated. The registration marks may then be added after a user has an opportunity to examine the composite image. This also provides a user with the opportunity to identify reference point for the location of the registration marks as also described above.

The system preferably utilizes a combination of the overall advertising layout scalability feature in conjunction with a database containing, or links to the desired registration mark information for various publications in order to ensure that the newly scaled registration marks for the corresponding underlying scaled image information is appropriate for the particular publication in which the scaled advertisement will be placed. For example, in the preferred exemplary embodiment, once both the image and the registration marks have been scaled to match the newly designated advertising copy size, the user is presented with the option of automatically adjusting the registration marks to match the requirements for a particular publication. Accordingly, a user is able to scale advertising layouts in order to match various size requirements while also ensuring that the registration marks accompanying the scaled advertising copy are appropriate for a given publication.

Those skilled in the art will appreciate that in order to perform scaling of an existing composite advertising layout, it is necessary to determine the largest scale factor for a given image size adjustment. For example, if the composite advertising layout has dimensions of four inches by five inches and the new advertising layout dimensions are to be 8 inches by 11 inches, the scale factor for this example would be 11/5. This accounts for unequal scaling of the image data in each of two scaled dimensions. This is necessary in order to eliminate the potential for distortion of the image data based on uneven scaling. The largest scaling for the two different dimensions is selected in order to eliminate any distortion of the image data.

Those skilled in the art will appreciate that various modifications and substitutions may be made to the systems and methods specifically disclosed within the present application.

I claim:

1. A method for entering advertising registration marks into an image comprising the steps of:
generating specification data for a plurality of advertising registration marks;
inserting a plurality of advertising registration marks into an image at locations determined by the specification data; and
displaying the image.

2. The method of entering advertising registration marks of claim 1, wherein one of the advertising registration marks is a trim mark.

3. The method of entering advertising registration marks of claim 1, wherein one of the advertising registration marks is a bleed mark.

4. The method of entering advertising registration marks of claim 1, wherein one of the advertising registration marks is a live mark.

5. The method of entering advertising registration marks of claim 1, wherein one of the advertising registration marks is a gutter mark.

6. The method of entering advertising registration marks of claim 1, wherein the step of generating specification data is comprised of a step of accessing a computer memory containing a correlation between a user designation and a plurality of dimensional specifications for advertising registration marks.

7. The method of entering advertising registration marks of claim 1, further comprising a step of scaling a relative size of at least one registration mark with respect to the image information.

8. A system for entering advertising registration marks into an image comprising:
a means for generating specification data for a plurality of advertising registration marks;
a means for inserting a plurality of advertising registration marks into an image at locations determined by the specification data; and
a means for displaying the image.

9. The system of entering advertising registration marks of claim 8, wherein one of the advertising registration marks is a trim mark.

10. The system of entering advertising registration marks of claim 8, wherein one of the advertising registration marks is a bleed mark.

11. The system of entering advertising registration marks of claim 8, wherein one of the advertising registration marks is a live mark.

12. The system of entering advertising registration marks of claim 8, wherein one of the advertising registration marks is a gutter mark.

13. The system of entering advertising registration marks of claim 8, wherein the step of generating specification data is comprised of a step of accessing a computer memory containing a correlation between a user designation and a plurality of dimensional specifications for advertising registration marks.

14. The system of entering advertising registration marks of claim 8, further comprising a step of scaling a relative size of at least one registration mark with respect to the image information.
